(19) United States
(12) Patent Application Publication
(10) Pub. No.: US 2012/0158499 A1
(43) Pub. Date: Jun. 21, 2012

(54) Providing Advertisements on a Social Network

(75) Inventors: Seyed Vahab Mirrokni Banadaki, New York, NY (US); Corinna Cortes, New York, NY (US); Edward Y. Chang, Palo Alto, CA (US)

(73) Assignee: Google Inc., Mountain View, CA (US)

(21) Appl. No.: 13/164,340

(22) Filed: Jun. 20, 2011

Related U.S. Application Data
(60) Provisional application No. 61/425,564, filed on Dec. 21, 2010.

(51) Int. Cl. G06Q 30/00

(52) U.S. Cl. 705/14.52

(57) ABSTRACT

In one implementation, a computer-implemented method includes receiving, at a server system, a request for an advertisement to provide to a first user of a social network, and determining, for each of a plurality of advertisements, a probability that the first user will select the advertisement based, at least in part, on previous propagations of the advertisement by one or more second users of the social network. The method can further include scoring, by the server system, the plurality of advertisements based upon the determined probabilities of selection by the first user and bids associated with the plurality of advertisements, and providing one or more of the plurality of advertisements for presentation to the first user based upon the scoring of the plurality of advertisements.

### CROSS-REFERENCE TO RELATED APPLICATIONS

This application claims priority under 35 U.S.C. §119(e)(1), to U.S. Provisional Application Ser. No. 61/425,564, filed on Dec. 21, 2010, the entire contents of which are incorporated herein.

### TECHNICAL FIELD

This document generally describes techniques, system, methods, and computer program products for providing advertisements on a social network.

### BACKGROUND

Social networks (e.g., FACEBOOK, TWITTER, LINKEDIN, YOUTUBE, etc.) have increased in popularity with users over recent years. A social network can be an online system that provides a forum for users who are geographically separated from each other but have indicated that they know each other, to interact with one another. Social networks can be aimed at different aspects of social interaction, such as friendship and business networking. A user of a social network can establish a profile on a social network that includes information about the user, such as the user's name, age, geographic location (e.g., current city/state/country of residence), interests (e.g., sports, music, hiking, etc.), acquaintances relationships (e.g., friends, business contacts, family, co-workers, classmates, etc.), and/or group memberships/affiliations (e.g., member of charitable group, employee of company, etc.). A user can have one or more pages on a social network that are viewable to other users (and/or to the public at large) and that include information from the user's profile and other information associated with the user, such as content (e.g., comments, status updates, images, videos, links, etc.) posted by the user and/or content posted by other users regarding the user (e.g., comments directed to the user, images in which the user is tagged, etc.).

Techniques of advertising to users of a social network have included targeting the social network and users of the social network with specific content. In some techniques, the entire social network has been targeted with advertisements directed to the general purpose of the social network (e.g., business).

### SUMMARY

This document describes techniques, system, methods, and computer program products for selecting and providing advertisements to users of a social network. Advertisements can be provided to users of social networks based on a probability that the users will select the advertisements. The probability that a user will select an advertisement indicates the relevance of the advertisement to a user. Probabilities of selection of an advertisement presented to a user of a social network can be determined based on a variety of factors related to social networks, such as user propagation of advertisements on a social network, relevance of advertisements to a user viewing the advertisements, and/or relevance of advertisement to a page (e.g., profile page of another user) on which the advertisements will be provided (e.g., displayed) to a user.

For instance, the probability that a user of a social network will select an advertisement can be based on previous propagations of the advertisement by other users of the social network. An advertisement can be propagated from a first user to a second user based on an action performed by the first user with respect to the advertisement (e.g., interacting with the advertisement, selecting a button to propagate the advertisement, etc.) and an acquaintance relationship between the first and second users on a social network (e.g., friendship, colleagues, profile page view, friend of friend, etc.). The probability that a user will select an advertisement can be determined based on weighted advertisement propagations. Advertisement propagations can be weighted based on a variety of factors, such as a level of influence of the propagating user on a social network and/or a relationship between the propagating user and the user for whom an advertisement is being selected.

In another example, the probability that a user of a social network will select an advertisement can also be based on the relevance of the advertisement to the user's interests as expressed by and/or inferred from the user's actions on the social network (e.g., interests expressed on the user's profile page, comments made by the user on the social network, etc.). For example, an advertisement regarding sports can be selected for presentation to a user of a social network based on the user indicating that he/she “likes” content on the social network (e.g., comments, pictures, videos, links, groups, etc.) related to sports.

In a further example, the probability that a user of a social network will select an advertisement can also be based on the relevance of the advertisement to a page of the social network that the user is viewing. For instance, if a user Alice requests the profile page of Bob from a social network computer system, the relevance of an advertisement to Bob's profile page (and/or the relevance of the advertisement to Bob) can be examined to determine whether to provide the advertisement to Alice in conjunction with her request for Bob's profile page. A variety of The content and/or context of Bob

A variety of mechanisms can be used to select an advertisement to provide to a user based on the probability that a user of a social network will select an advertisement, such as conducting an auction that takes into account advertiser bids.

In one implementation, a computer-implemented method includes receiving, at a server system, a request for an advertisement to provide to a first user of a social network, and determining, for each of a plurality of advertisements, a probability that the first user will select the advertisement based, at least in part, on previous propagations of the advertisement by one or more second users of the social network. The method can further include scoring, by the server system, the plurality of advertisements based upon the determined probabilities of selection by the first user and bids associated with the plurality of advertisements, and providing one or more of the plurality of advertisements for presentation to the first user based upon the scoring of the plurality of advertisements.

In another implementation, a system for providing advertisements to users of a social network includes one or more computer servers, and an interface to the one or more servers that is configured to receive a request for an advertisement to provide to a first user of a social network. The system can also include a selection probability module of the one or more servers that is configured to determine, for each of a plurality of advertisements, a probability that the first user will select the advertisement based upon, at least in part, previous propagations of the advertisement by one or more second users of the social network. The system can further include a scoring component of the one or more servers that is configured to score the plurality of advertisements based upon the determined probabilities of selection by the first user and bids associated with the plurality of advertisements. The system can additionally include an advertisement server module of the one or more servers that is configured to provide one or more of the plurality of advertisements for presentation to the first user based upon the scoring of the plurality of advertisements.

In another implementation, a computer program product tangibly can be embodied in a non-transitory machine-readable storage device, the computer program product including instructions that, when executed, cause operations to be performed that include receiving a request for an advertisement to provide to a first user of a social network. The operations can additionally include determining, for each of a plurality of advertisements, a probability that the first user will select the advertisement based upon, at least in part, previous propagations of the advertisement by one or more second users of the social network. The operations can also include scoring the plurality of advertisements based upon the determined probabilities of selection by the first user and bids associated with the plurality of advertisements. The operations can further include providing one or more of the plurality of advertisements for presentation to the first user based upon the scoring of the plurality of advertisements.

Various advantages can be realized with certain implementations, such as more accurately determining probabilities that users of social networks will select advertisements. The disclosed techniques can take advantage of social network features and associated information that indicate whether a user is likely to be interested in an advertisement. For example, information regarding advertisement propagations can indicate whether a user is likely to select a particular advertisement when it is presented in association with particular content from the social network.

Other advantages can include providing advertisers with incentives to generate higher quality advertisements for presentation to users of a social network. An increase on the number of high quality advertisements presented to a user can improve the user's viewing experience. An increase on the number of high quality advertisements can also increase the amount of advertising revenue generated in association with a social network, as it may be more likely to increase user selections of advertisements. An increase on the likelihood that users will select and advertisement can be beneficial for an advertiser as well. For example, users can be more likely to visit a landing page associated with a high quality advertisement. In another example, an advertiser can pay less to present high quality advertisements to users when the users are more likely to select the high quality advertisements.

The details of one or more embodiments are set forth in the accompanying drawings and the description below. Other features, objects, and advantages will be apparent from the description and drawings, and from the claims.

### DESCRIPTION OF DRAWINGS

FIG. 1 is a conceptual diagram showing an example advertising server system for providing advertisements to users of social networks based on probabilities of selection.

FIG. 2 is a diagram of an example system for providing advertisements to users of social networks based on probabilities of selection.

FIGS. 3A-B depict a flowchart showing an example technique for providing advertisements to users of social networks based on probabilities of selection.

FIG. 4 is a block diagram of computing devices that may be used to implement the systems and methods described in this document, as either a client or as a server or plurality of servers.

Like reference symbols in the various drawings indicate like elements.

### DETAILED DESCRIPTION

This document describes techniques, methods, systems, and computer program products for providing advertisements (e.g., text-based electronic advertisements, electronic video advertisements, interactive electronic games, etc.) to users of a social network (e.g., FACEBOOK, TWITTER, YOUTUBE, LINKEDIN, etc.). In particular, advertisements can be provided to users of social networks based on a probability that the users will select an advertisement. Probabilities of selection can be determined based on a variety of information derived from social networks, such as advertisement propagation in social networks, advertisement relevance to a user based on the user's activity on social networks, and/or advertisement relevance to a social network page (e.g., a user profile page, a group page, etc.) on which the advertisement is to be presented.

Various computer systems have used probabilities of selection, such as click-through-rates (the rate at which users “click on” an advertisement), to determine which advertisement(s) to select for a given user. For example, in response to a search query a search engine computer system can present advertisements to a user based on a probability that the user will select the advertisements. The probability of such a selection can be based on the relevance of an advertisement to a search results page being presented to a user in response to a search query. Such a probability of selection can be determined based on a comparison of search queries and advertisements. For instance, if a user submits a search query for “running shoes,” a first advertisement that is advertising a particular brand of running shoes can be determined to have a greater associated probability of selection by the user than a second advertisement directed to cameras. Such probabilities of selection can be derived based on the user's expressed interest in running shoes, as indicated by the search query “running shoes.”

A variety of techniques can be used to select advertisements for users based on probabilities of selection, such as auctions. For instance, in an example auction, advertisers submit bids indicating an amount the advertisers are willing to pay to present their advertisements to users. As advertising opportunities become available (e.g., serving a requested web page with reserved space for advertisements), probabilities of selection can be determined for advertisements. A determined probability of selection can indicate a probability that a user will select an advertisement if the advertisement is presented in a particular advertising opportunity (e.g., presented with a particular page of a social network). For a given advertising opportunity, advertisements can be scored and ranked based on determined probabilities of selection and bids for the advertisements. Advertisements can be scored in a variety of ways. For instance, an advertisement can be scored by multiplying a probability of selection for the advertisement (for a given advertising opportunity) with a bid for the advertisement. Advertisements can be ranked by the determined scores and the top x ranked advertisements (where x is the number of available advertising slots) can be selected for presentation. For each of the selected advertisements, a minimum amount that a corresponding advertiser pays can be the score of the advertisement ranked below the selected advertisement divided by the probability of selection for the selected advertisement.

For example, ranked scores s₁₋ₙ (where s₁ is the highest ranked score and sₙ is the lowest ranked score) can be determined for advertisements a₁₋ₙ, based on corresponding probabilities of selection c₁₋ₙ and advertiser bids b₁₋ₙ. For instance, the scores can be ranked such that c₁*b₁ (s₁)≧c₂*b₂ (s₂)≧ . . . cₙ*bₙ (sₙ). An amount an advertiser will pay (p₁) for advertisement a₁ to be presented in an available advertising slot can be determined to be p₁=s₂/c₁. Using this auction technique, an advertiser pays less to present an advertisement with a greater probability of selection based on the probability of selection for an advertisement being the denominator for determining the payment amount. This auction technique provides advertisers with an incentive to present higher quality and more relevant advertisements that will have a greater probability of selection and, as a corollary, cost the advertiser less to present to a user.

Accurate determination of the probability of selection for an advertisement when the advertisement is presented for a particular advertising opportunity can be difficult, especially when presenting advertisements in a social network setting. This document describes techniques, methods, systems, and computer program products for more accurately determining probabilities of selection for advertisements presented to users of a social network. Probabilities of selection of an advertisement presented to a user of a social network can be determined based on a variety of factors related to social networks, such as user propagation of advertisements on a social network, relevance of advertisements to a user viewing the advertisements, and/or relevance of advertisement to a page (e.g., profile page of another user) on which the advertisements will be provided (e.g., displayed) to a user.

Advertisement propagation involves an advertisement being propagated from a first user of a social network to a second user of the social network based on an action of the first user that indicates the first user's interest in the advertisement. Such an action by the first user can be explicit and/or implicit with regard to propagation of the advertisement. For example, advertisements can be presented with selectable user interface (UI) elements (e.g., buttons, links, etc.) that users can select to explicitly propagate advertisements to other users of the social network. An advertisement can be propagated to other users having an acquaintance relationship (e.g., friendship, colleagues, family members, friends of friends, users who viewed each other's profiles, etc.) with the propagating user. A propagating user may be presented with an interface to designate one or more of his/her acquaintances (e.g., friends, co-workers, classmates, friends of friends) to which an advertisement should be propagated.

In another example, an advertisement can be implicitly propagated based on a user interacting with an advertisement (e.g., selecting a link presented with the advertisement, playing a video embedded with the advertisement, interacting with a game provided with the advertisement, etc.). Such interaction with an advertisement can indicate that a user is interested in the advertisement, and can cause an advertisement to be propagated to a user's acquaintances on a social network. A social network system may seek a user's permission to implicitly propagate their advertising interests to other users.

Propagated advertisements can be presented to users with information identifying a user from which the advertisement has been propagated. For example, if a first user propagates an advertisement to his/her friends, the advertisement can be presented to his/her friends with a message indicating that the first user was interested in and/or liked the advertisement.

In another example of advertisement propagation, a social network system can provide aggregate-level information with an advertisement to a user. Such aggregate-level information can include a variety of details regarding interactions with an advertisement by a user's acquaintances, such as names and/or the number of acquaintances who liked, tagged, propagated, or commented on an advertisement. For example, an advertisement can be presented to a first user of a social network with information indicating a total number of the first user's friends who selected and/or liked the advertisement, and with information identifying the most recent friends to have selected and/or liked the advertisement.

As described in further detail below, various techniques can be used to determine probabilities of selection for advertisements based on, at least, advertisement propagation.

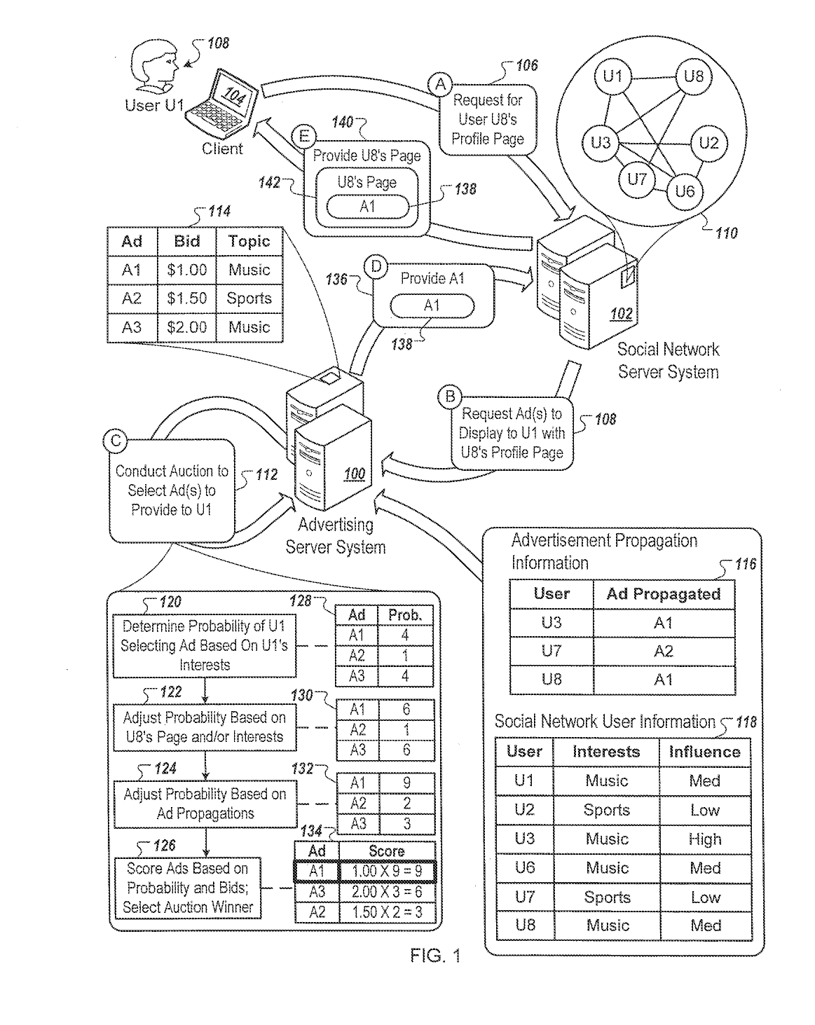

FIG. 1 is a conceptual diagram showing an example advertising server system 100 for providing advertisements to users of social networks based on probabilities of selection. In particular, the advertising server system 100 can determine probabilities of selection based on various aspects of social networks that may indicate whether a user is more or less likely to select an advertisement, such as advertisement propagations, interests of a user, and/or content of a page with which an advertisement is to be presented.

The conceptual diagram depicted in FIG. 1 also includes a social network server system 102 that is configured request from the advertising server system 100 advertisements to present with social network content. FIG. 1 also depicts an example client computing device that is configured to request social network content (e.g., a profile page of a user on a social network) from the social network server system 102.

The advertising server system 100, the social network server system 102, and the client computing device 104 can each be any of a variety of computing devices, such as a laptop computer, a desktop computer, a mobile telephone, a smart phone, a computer server system, or any combination thereof. The advertising server system 100, the social network server system 102, and the client computing device 104 can communicate through any of a variety of communications channels, such as the Internet, a local area network (LAN), a wide area network (WAN), a virtual private network (VPN), a wireless network (e.g., wifi, cellular telephone network, 3G/4G data network, etc.), or any combination thereof.

As depicted at step A (106) in the example, the client computing device 104 provides a request to the social network server system 102 for user U8's profile page. In this example, the client computing device 104 is associated with user U1 (108). The client computing device 104 may have previously received an electronic document (e.g., a web page) and/or an application (e.g., standalone social network application, etc.) through which the request was generated by user U1. For example, using the client computing device 104, the user U1 may have previously requested a web page (e.g., hypertext markup language (HTML) document, FLASH document, etc.) of a social network that is hosted by the social network server system 102 and that contains a selectable links to profile pages for U1's friends on the social network. In response to the user U1 selecting a link corresponding to user U8 in the requested web page, the client computing device 104 can cause the request to be transmitted to the social network server system 102.

In response to receiving the request, the social network server system 102 can begin to serve the request. Serving such a request can include retrieving information associated with the request (e.g., retrieving text and/or images that user U8 has designated to appear in his/her profile page) and/or formatting the data for presentation to user U1 (e.g., generating an HTML document that includes the retrieved information). As indicated by step B (108), the social network server system 102 requests one or more advertisements to provide with user U8's profile page, as requested by the client computing device 104, from the advertising server system 100. The social network server system 102 can include information with the request (and/or make such information accessible by the advertising server system 100) regarding user U1 and/or user U8, such as information regarding portions of a social graph 110 that are relevant to users U1 and/or U8, social network profile information for users U1 and/or U8 (e.g., interests, group affiliations, etc.). and/or information regarding user U1 and/or U8's social network activity (e.g., profile page views, comments, liked content, etc.).

A social network of users can be represented as a graph of users (nodes) connected to each other by acquaintance relationships (edges), as exemplified by the social graph 210. Acquaintance relationships can be explicit relationships among users of a social network. For instance, a mutually agreed-upon friend designation among two users can be explicit. Acquaintance relationships can also be implicit. For example, even though users U1 and U7 do not have an explicit friendship relationship, an acquaintance relationship may implicitly exist between them if user U1 visits user U7's profile page, user U1 interacts with user U7 via an interface on the social network (e.g., a chat room, email exchange, etc.), and/or user U1 and user U7 share a friend in common (e.g., they both have an explicit friendship relationship with users U3, U6, and U8).

When a social network has a multitude of users with interconnecting acquaintance relationships, a resulting social graph (e.g., the social graph 110) can be quite large in size. Portions of a social network that are relevant to a user can include immediate connections to the user as well as connections within a threshold distance of the user in the graph (e.g., friends of friends, etc.). Relevant portions of a social network can also include a sub-graph of which a user is a part. A sub-graph can be a portion of a social network graph that includes a group of users that have many acquaintance relationships with each other but few acquaintance relationships with users outside of the group.

In response to receiving the request from the social network server system 102, the advertising server system 100 performs an auction to select one or more advertisements to provide to user U1 with U8's profile page, as indicated by step C (112). Such an auction can be performed based on bids to display advertisements and a determined probability that user U1 will select an advertisement when it is presented with user U8's profile page—similar to the auction technique discussed above. Example advertisement bids are presented in table 114, which depicts bids of $1.00, $1.50, and $2.00 for advertisements A1-A3, respectively. Table 114 also includes information indicating that the advertisements A1-A3 are associated with topics music, sports, and music, respectively. These topics may have been provided as keywords and/or user interests bid on by advertisers.

The advertising server system 100 can determine probabilities of selection for the user U1 and the advertisements A1-A3 based on a variety of information related to social networks. In the depicted example, the advertising server system 100 uses advertisement propagation information (table 116), social network user information (table 118), and information regarding the social graph 110. The table 116 depicts example propagations of the advertisements A1-A3 by the users depicted in the social graph 110. For instance, the table 116 indicates that users U3 and U8 propagated advertisement A1, and that user U7 propagated advertisement A2. The advertisements A1 and A2 may have been propagated by users U3, U7, and U8 using any of a variety of propagation techniques, such as express and implicit advertisement propagation as described above.

The table 118 depicts example information regarding the users U1-U3 and U6-U8, as provided in the social graph 110. In particular, the table 118 depicts simplified interests of the users U1-U3 and U6-U8 in sports and music. Such interests can be expressly provided by users (e.g., users posting their interests on their profile page) and/or implicitly derived from user actions (e.g., comments discussing subjects of interest, viewing content associated with an interest, etc.).

A user's influence on a social network can indicate an extent to which a user's actions on a social network influence the behavior of other users on the social network. For example, if an influential user posts a comment on his/her profile indicating that a particular movie is “very good” and “a must see,” friends of the influential user may be more likely to go and see the movie. A user's influence can be determined based on the user's level of activity and/or acquaintance relationships on a social network. A user's activity level can be a measure of a user's interactions on a social network (e.g., comments posted, messages sent to other users, new friends made, etc.).

A user's influence can also be based on a quantity and/or a significance of the user's acquaintance relationships. A user with more friends may be more influential than a user with fewer friends. For example, a user with a greater number of acquaintance relationships may be determined to be more influential than a user with a fewer number of acquaintance relationships. A user's influence score can also be based on the significance of the user's acquaintance relationships. A user with more significant acquaintance relationships can have greater influence on a social network than a user with less significant acquaintance relationships. The significance of a user's acquaintance relationship can be based on a level of influence of the user's acquaintances and/or whether the acquaintance relationship connects separate sub-graphs of a social network. In some instances, a user's acquaintance relationship with a more influential user may be more significant than an acquaintance relationship with a less influential user (e.g., influence of a more influential user can cause the more influential user to influence additional users and allow the subject matter of influence to propagate more broadly across a social network). In other instances, a user's acquaintance relationship with a less influential user may be more significant than an acquaintance relationship with a more influential user (e.g., the less influential user is more likely to be influenced).

In the depicted example, the influence of users U1-U3 and U6-U8 is represented as high, medium, and low, where a user that has a “high” level of influence is more influential than a user that has a “med” level of influence.

The advertising server system 100 can use the information from tables 116 and 118 regarding advertisement propagation and social network user information, respectively, as well as other information not depicted, to determine a probability that user U1 will select the advertisements A1-A3. For example, the advertising server system 100 can determine that the user U1 is more likely to select a first advertisement that relates to a topic in which U1 is interested and that was propagated by an influential acquaintance of U1 that is interested in the same topic, than a second advertisement related to a topic U1 is not interested in and that has not been propagated by an acquaintance of U1.

Other information, including non-social network information, can be used by the advertising server system 100 to determine a probability that the user U1 will select an advertisement. For instance, the advertising server system 100 can determine probabilities of selection for the user U1 based on demographic information for the user U1 and/or for other users, such as age, gender, occupation, income, education, and/or geographic location.

Example steps for conducting the auction described in step C (112) include steps 120-126, which regard determining probabilities of selection for the user U1 and the advertisements A1-A3, scoring the advertisements A1-A3 based on the determined probabilities of selection and advertisement bids, and selecting an auction winner based on the scores.

Referring to step 120, the advertising server system 100 determines the probability of user U1 selecting the advertisements A1-A3 based on U1's interests, as indicated in the social network user information table 118. As indicated above, user interests can be identified and/or inferred from a variety of source, such as a user's profile page, comment posts, and/or page views. User interests that more closely align with the subject matter of the advertisements A1-A3 can result in a greater probability of selection by the user U1. Additionally, as user interests may change over time, the timeframe within which a user has expressed interests can be taken into account to determine probabilities of selection. For instance, if a user is interested in both sports and music, but the user has recently been generating and viewing more content regarding sports than music, the user may be determined to have a greater probability of selection with regard to advertisements related to sports than music.

An example determination of the user U1's probability of selection for advertisements A1-A3 based on step 120 is provided in table 128. In this simplified example, the probability of selection for advertisements A1 and A3 is determined to be greater than the probability of selection for advertisement A2 based on the user U1 being interested in music, which is the subject of advertisements A1 and A3. In contrast, the advertisement A2 is related to sports. The values used to represent the probability of selection in this example range from 1 to 10, where 1 is the lowest probability of selection and 10 is the greatest probability of selection. Any of a variety of values and value ranges can be used to represent probabilities of selection (e.g., 0.0-1.0; −10-10; 1-100; etc.). The table 128 provides example probabilities of selection for the advertisements A1-A3 resulting from step 120 as 4, 1, and 4, respectively.

At step 122 the advertising server system 100 adjusts the probabilities of selection determined from step 120 based on user U8's profile page, as requested by the client computing device 108 and user U1, and/or interests of the user U8. The greater similarity between an advertisement and the user U8's profile page (an example landing page) and/or interests, the greater the probability that the user U1 will select the advertisement. The user U1's request for U8's profile page can indicate that the user U1 is interested in content contained on U8's profile page and/or in learning more about user U8's interests. As such, a greater degree of similarity between the subject matter of an advertisement and user U8's profile page and/or interests can indicate a greater probability that the user U1 will select the advertisement.

Table 130 provides example adjustments to the probability of selections depicted in table 128 after the application of step 122. Given that user U8 is also interested in music and the advertisements A1 and A3 are related to music, the probabilities of selection for advertisements A1 and A3 can increase. The amount by which the probabilities of selection increase can vary depending on a variety of factors, such as a degree of similarity between the subject matter of an advertisement and the content and/or interests associated with a user's landing page and/or the prominence of relevant content on a user's landing page (e.g., content displayed near the top of a landing page versus being displayed near the bottom). As shown in the table 130, the probability of selection for the advertisements A1 and A3 increases to 6.

Step 124 involves adjusting the probabilities of selection for user U1 and the advertisements A1-A3 based on user propagation of advertisements A1-A3. As provided in table 116, ads A1 and A2 have been propagated, but advertisement A3 has not. Advertisement A1 has been propagated by users U3 and U8, and advertisement A2 has been propagated by user U7. The advertisements A1 and A2 may have been propagated by the user U3, U7, and U8 using various propagation techniques, such as the propagation techniques discussed above with regard to explicit and implicit propagation. Advertisement propagations (and the absence of advertisement propagations) by other users can provide a variety of indications regarding the probability that the user U1 will select the advertisements A1-A3. For example, propagation of an advertisement can indicate that the advertisement is a high quality advertisement (e.g., the advertisement includes a captivating image) and/or that it promotes a product and/or product offer in which users are interested (e.g., the advertisement promotes a sale with bargain prices).

The advertisement propagations can be weighted based on a variety of factors, such as an influence score associated with the propagating user and/or the type of relationship (e.g., friends, friends of friends, etc.) between the propagating user and the user for whom an advertisement is being selected. An influence score can represent a level of influence of a user on a social network, as described above. Propagation of an advertisement by a more influential user can indicate that a user viewing the advertisement has a greater probability of selection than propagation by a less influential user. Similarly, propagation by a user that has a closer relationship to a viewing user (e.g., the two users are direct friends on a social network who correspond frequently) can indicate that the viewing has a greater probability of selection than propagation by another user with a more distant connection to the viewing user (e.g., the viewing user viewed the other user's profile once a month ago).

For example, the users U3, U7, and U8 are depicted in table 116 as having propagated advertisements. As shown in the table 118, the user U3 has a high level of influence on the social network, the user U7 has a low level of influence on the social network, and the user U8 has a medium level of influence on the social network. The users U3 and U8 are depicted as having a direct acquaintance relationship with the user U1 on the social graph 100, and the user U7 is depicted as having an indirect acquaintance relationship with U1. Based on these factors (other factors aside), the propagation of advertisement A1 by user U3 can be weighted more than the propagation of advertisement A1 by user U8, which can be weighted more than the propagation of advertisement A2 by user U7. When aggregated, the propagations of A1 by users U3 and U8 can provide a greater indication that user U1 will select the advertisement A1 than an indication that U1 will select advertisement A2 based on the propagation of A2 by the user U7.

Weighting can also take into account whether a propagating user is influential with regard to the subject of an advertisement. For instance, propagations of an advertisement pertaining to sports by a first user that is influential with regard to sports, and by a second user that is influential with regard to music can provide different indications regarding a probability of selection by a user viewing the advertisement. In such an example scenario, the propagation by the first user can more strongly indicate that the viewing user will select the advertisement than the propagation by the second user based on the first user being influential with regard to the subject of the advertisement. For instance, the first user may post a lot of content regarding sports (e.g., scores, analysis of teams and players). The first user may have developed a reputation among other users of a social network as being knowledgeable regarding sports and may be more likely to defer to his/her opinion regarding advertisements related to sports (as demonstrated through an advertisement propagation) than other users who do not have such a reputation.

Advertisements propagations can also be weighted according to whether the propagation was performed by a user who is associated with a page on which an advertisement may be presented (e.g., user U8's profile page in the present example, a group page of which the propagating user is a member, a page on which content (e.g., comments) generated the propagating user is displayed). For instance, the users U3 and U8 are both depicted as having propagated the advertisement A1. When determining the probability that the user U1 will select an advertisement presented with user U8's profile page, the propagation by the user U8 can be weighted more than the propagation by the user U3.

In some implementations, when a user that propagated an advertisement and an advertising opportunity exists on the propagating user's profile page (e.g., user U8 propagated advertisement A1 and advertisements are being selected for presentation on user U8's profile page), the advertisement propagation can be weighted by a maximum amount (e.g., propagation of A1 by user U8 can be weighted by a maximum amount). Such a weighting scheme can reflect the fact that, through the request for the propagating user's profile page, the viewing user has indicated that he/she is currently interested the propagating user and/or information that the propagating user finds important enough to include/permit on his/her profile page. Based on this demonstrated interest in the propagating user, the viewing user may be more likely to be interested in advertisements that the propagating user was sufficiently interested in to propagate.

Other weighting schemes for advertisement propagations not described in this document can also be used (alone or in conjunction with one or more of the weighting schemes discussed above).

Table 132 provides example adjustments to the probability of selections depicted in table 130 after the application of step 124. Based on the various adjustments to the probability of selection based on advertisement propagations (and associated weights for advertisement propagations), the table 132 shows that the probability of selection for advertisement A1 increases based on propagations by users U3 and U8, the probability of selection for A2 increases based on propagation by user U2, and the probability of selection for A3 decreases based on no propagations. As depicted in this example, the probability of selection for A1 increases by a greater amount than the probability of selection for A2. This difference can be attributed to the advertisement A1 having been propagated more than A2 and/or any of the various weighting factors discussed above (e.g., users U3 and U8 have direct acquaintance relationships with U1 whereas user U7 has an indirect acquaintance relationship with U1).

Steps 120-124 can be performed in any order or in any combination. Additional steps not described can be performed in addition to and/or instead of the steps 120-124 to determine the probability of selection for advertisements given a particular user (e.g., user U1) and an advertising opportunity (e.g., providing an advertisement on user U8's profile page).

At step 126, the advertising server system 100 scores the advertisements A1-A3 based on the determined probabilities of selection (as depicted in the table 132) and the associated bids (as depicted in the table 114). The scores can be used as part of an auction for the advertising opportunity and to select an advertisement for presentation to user U1 on user U8's profile page. Such an auction can be similar to the example auction technique described above. As depicted in the table 134, the advertisements A1-A3 are scored by multiplying the bid amount by the probability of selection. The advertisements can be ranked based on the resulting scores and an auction winner or winners can be selected depending on the number of available advertising opportunities. For example, if two advertisements are going to be presented to user U1 with the user U8's profile page, the top two ranked advertisements can be selected for presentation. In the present example, the advertisement A1 is selected for presentation based on A1 having the greatest score among the advertisements A1-A3.

As demonstrated by the table 134, the advertisement A1 is selected for presentation to the user U1 even through it has the lowest associated bid among the advertisements A1-A3. The advertisement A1 has the highest ranking based its associated probability of selection by user U1, as described above. Such an advertisement selection technique can provide an incentive to advertisers to generate advertisements that will generate a greater associated probability of selection by users. One way advertisers can do this is by providing higher quality and/or more relevant advertisements to users who, in turn, may be more likely to demonstrate interest in the advertisements, such as through advertisement propagation. As a corollary, such an advertisement selection technique can benefit users, whose social network experience may be improved by the presentation of higher quality and/or more relevant advertisements (over lower quality and/or less relevant advertisements).

In addition to improving their chance of being selected, advertisers can pay less to present advertisements to users when their advertisements have a greater probability of selection. For instance, using the auction technique described above, the amount paid for a first place advertisement (A1) can be p₁=s₂/c₁, where s2 is the score for the second place advertisement (A3) divided by the probability of selection for the first place advertisement. With the probability of selection for the winning advertiser being the denominator, an advertiser pays less when the probability of selection for an advertisement is greater. In this example, the amount paid for A1 can be $0.67 (6 divided by 9), which ends up being less than the bid for A1 based on the probability of selection (9) for A1. As described above, a variety of schemes can be used to determine when an advertiser is responsible for payment of such an amount, such as a pay per impression advertising scheme (amount paid when the advertisement is viewed), a pay per click advertising scheme (amount paid when advertisement is selected), and/or a pay per conversion scheme (amount paid when a sale of the advertised product is completed).

As described above, users that propagate an advertisement can also be paid when the advertisement they have propagated is presented to other users based, at least in part, on their propagation. For example, the users U3 and/or U8 can receive a portion of the revenue ($0.67) that is generated from the presentation of advertisement A1 to user U1. The amount paid to such users can be determined in a variety of ways, such as a percentage of the revenue (e.g., 1%, 5%, 10%, 25%, etc.), a fixed amount (e.g., $0.01, $0.05, $0.10, etc.), and/or an amount determined based on the significance of the user's action in causing an advertisement to be presented to another user (e.g., without user's propagation the advertisement would not be presented to user). Similarly, the amount of revenue share divided among different users also can vary. In particular, one can see the path of ad propagation and give more revenue share to the final contributors to this path or divide the revenue equally among people who share the revenue with users contributing to propagate an ad to a final user.

As indicated at step D (136), the advertising server system 100 can provide the selected advertisement A1 (138) to the social network server system 102. The social network server system 102 can generate the user U8's profile page (e.g., gather and assemble information to be provided on user U8's profile page) and can add the advertisement A1 to the page (e.g., add code to a web page that causes the advertisement A1 to be retrieved and/or displayed with the profile page).

As indicated by step E (140), the social network server system 102 provides U8's profile page (142) with the advertisement A1 (138) to the client computing device 104 for presentation to the user U1. The page 142 and the advertisement A1 can be provided in any of a variety of electronic data formats, such as HTML, extensible markup language (XML), SHOCKWAVE/FLASH, JAVASCRIPT, and/or HTML5. Using any of a variety of applications installed (as software and/or hardware) on the client computing device 104, page 142 and the advertisement A1 can be provided (e.g., displayed, audibly played, etc.) to the user U8 by the client computing device 104.

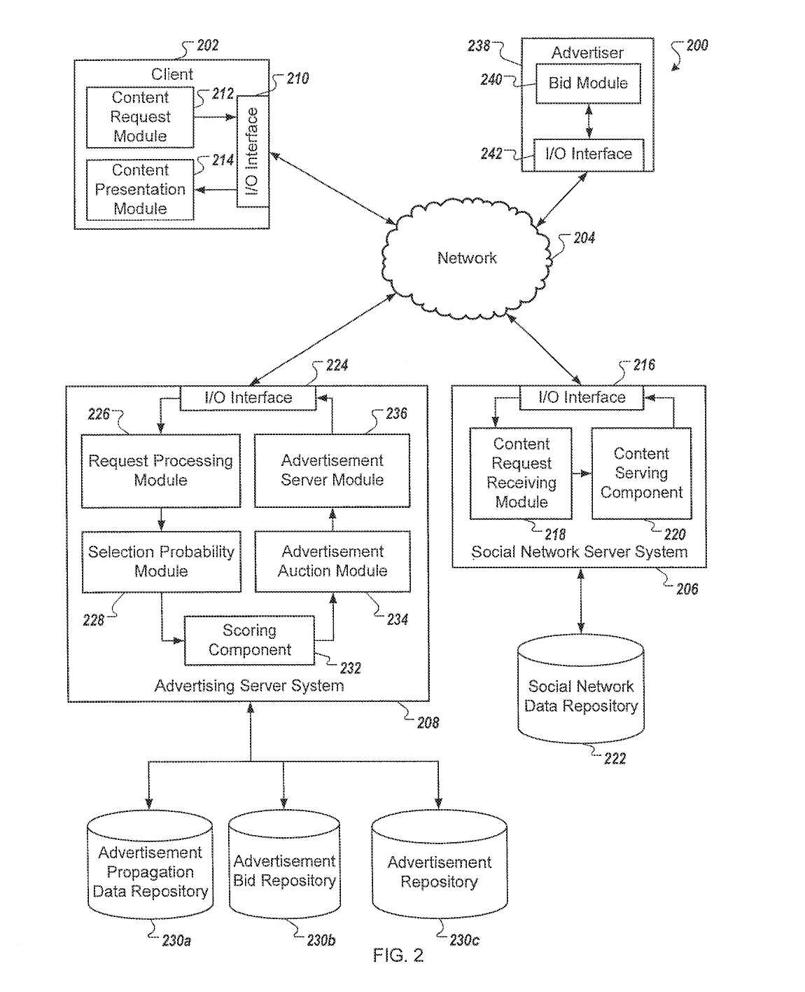

FIG. 2 is a diagram of an example system 200 for providing advertisements to users of social networks based on probabilities of selection. The system 200 includes a client computing device 202 that requests content (e.g., pages of a social network) through a network 204 from a social network server system 206 (e.g., a directions server system, a search engine, etc.). The social network server system 206 can cause advertisements be provided from an advertising server system 208 to the client computing device 202 (directly or indirectly) with the requested content. The advertising server system 208 is similar to the advertising server system 100 described above with regard to FIG. 1. The client computing device 202 and the social network server system 206 are similar to the client computing device 104 and the social network server system 102, as described above with regard to FIG. 1.

The client computing device 202 can be any of a variety of computing devices, such as a laptop computer, a desktop computer, a netbook, a mobile telephone, a smartphone, a tablet computing device, and/or a computer server system. The client computing device 202 includes an input/output (I/O) interface 210 that the device 202 uses to communicate with other computing devices over the network 204. The I/O interface 210 can be any of a variety of communications interfaces, such as an Ethernet card, a wireless network card, a cellular network transceiver, or any combination thereof. The client computing device 202 includes a content request module 212 that is configured to provide requests for content to the social network server system 206 over the network 204. The content request module 212 can be configured to make such requests in response to user input, such as a user selecting a link and/or button provided by an electronic document (e.g., web page). The client computing device 202 can also include a content presentation module 214 that is configured to provide (e.g., display, audibly play, etc.) content and advertisements on the client computing device 202.

The network 204 can be any of a variety of networks over which computing devices can communicate. For instance, the network 204 can include a LAN, a WAN, a VPN, a wireless network, the Internet, a point-to-point network, a telephone network (e.g., public switched telephone network (PSTN)), a cellular telephone network, a 3G/4G network, or any combination thereof.

The social network server system 206 can be any of a variety of computing devices, such as a desktop computer, a laptop computer, a distributed computer server system, a dedicated computer server system, and/or a colocated computer server system. The social network server system 206 is configured to serve requested content to various computing devices, such as the client computing device 202. The social network server system 206 can be configured to serve a variety of content, such profile pages that include text, audio data, videos, and/or images.

The social network server system 206 includes an I/O interface 216 that is configured to communicate with other computing devices over the network 204. The I/O interface 216 can be similar to the I/O interface 210 of the client computing device 202. The social network server system 206 further includes a content request receiving module 218 that is configured to receive requests for content, such as requests from the client computing device 202. The content request receiving module 218 can cause a content serving component 220 of the social network server system 206 to identify and serve the content requested by the client computing device 202, such as social network pages. The content serving component 220 can access a social network data repository 222 to identify/serve at least some of the requested content. The social network data repository 222 can be any of a variety of mechanisms for storing data, such as a database and/or a file system. The social network data repository 222 can store a variety of information regarding social networks, such as user generated content (e.g., profile page content, comments, uploaded images), user relationship information (e.g., friendship information, profile page view information), and/or information indicating a user's influence on a social network.

As part of processing a received request for content, the content request receiving module 218 can also cause a request for one or more advertisements to be provided to the advertising server system 208.

The advertising server system 208 can be any of a variety of computing devices, such as a desktop computer, a laptop computer, a distributed computer server system, a dedicated computer server system, and/or a colocated computer server system. The advertising server system 208 is configured to provide, at least, advertisements for presentation with content from the social network server system 206, similar to the advertising server system 100 described above with regard to FIG. 1. The advertising server system 208 includes an I/O interface 224 that is similar to the I/O interfaces 210 and 216, as described above, and that is configured to receive requests for promotional information.

The advertising server system 208 also includes a request processing module 226 that is configured to choose a technique for selecting advertisements to provide in response to a request for advertisements from a computing device, such as the social network server system 206. The advertising server system 208 can be configured to provide advertisements to a variety of computing systems, including multiple different social network server system and non-social network server systems. In response to determining that a received request is for an advertisement to be presented to a user of a social network, the request processing module 226 can cause a selection probability module 228 to determine probabilities of selection for the request.

The selection probability module 228 is configured to determine probabilities that a user of a social network will select various advertisements when presented as with a particular page (e.g., a social network page, a non-social network page that includes some social network content). The selection probability module 228 can determine probabilities of selection based on a variety of factors, such as interests of a user to whom the advertisements will be presented (e.g., step 120), a page on which an advertisement will be presented (e.g., step 122), and/or advertisement propagations (e.g., step 124). The selection probability module 228 can make such determinations using data from a variety of sources, such as data repositories 230a-c. For instance, the selection probability module 228 can access the advertisement propagation data repository 230a to retrieve information regarding advertisement propagations, such as information advertisements that were propagated, when they were propagated, and who propagated them.

A scoring component 232 can score advertisements based on probabilities of selection determined by the selection probability module 228 and bids for such advertisements. Scoring can be conducted using a variety of techniques, such as the techniques described above with regard to step 126 depicted in FIG. 1. Bids can be retrieved from an advertisement bid repository 230b.

An advertisement auction module 234 can select an advertisement based on the scores determined by the scoring component 232 and can determine an amount that an advertiser will pay for presentation of an advertisement. The advertisement auction module 234 can use a variety of techniques to make such a selection and price determination, such as those discussed above with regard to advertising server system 100 and step 126.

An advertisement server module 236 can provide selected advertisement to the social network server system 206 through the I/O interface 224 and the network 204. Advertisements can be stored and retrieved from an advertisement repository 230c. The social network server system 206 can integrate the selected advertisement with the requested content such that the advertisement is presented on the client computing device 202 in conjunction with the requested content. For example, the social network server system 206 can add code to an electronic document that includes the requested content that causes the advertisement to be displayed as part of the document.

The social network server system 206 can provide the requested content to the client computing device 202 using the content serving component 220, the I/O interface 216, and the network 204. The client computing device 202 can receive the requested content and the selected promotional information through the interface 210 and can present the requested content and/or selected promotional information to a user of the client computing device 202 using the content presentation module 214.

In some implementations, the social network server system 206 can provide code to client with the requested content that, when interpreted and/or executed by the client computing device 202, can cause the client computing device 202 to request one or more advertisements from the advertising server system 208. In such implementations, the advertising server system 208 can provide advertisements to the client computing device 202 through the network 204, instead of providing selected advertisements to the social network server system 206. The code provided to the client computing device 202 can include code to receive and present advertisements from the advertising server system 208 on the client computing device 202.

The system 200 can also include an advertiser computing device 238 that is configured to provide advertisements and/or advertising bids to the advertising server system 208 over the network 204. The advertiser computing device 238 can be any of a variety of computing device, such as those described with regard to the client computing device 202. The advertiser computing device 238 can include a bid module 240 that is configured to receive bids from a user and to transmit such bids to the advertising server system 208. The advertiser computing device 238 additionally includes an I/O interface 242, similar to the I/O interface 210, that is configured to communicate with the advertising server system 208 over the network 204.

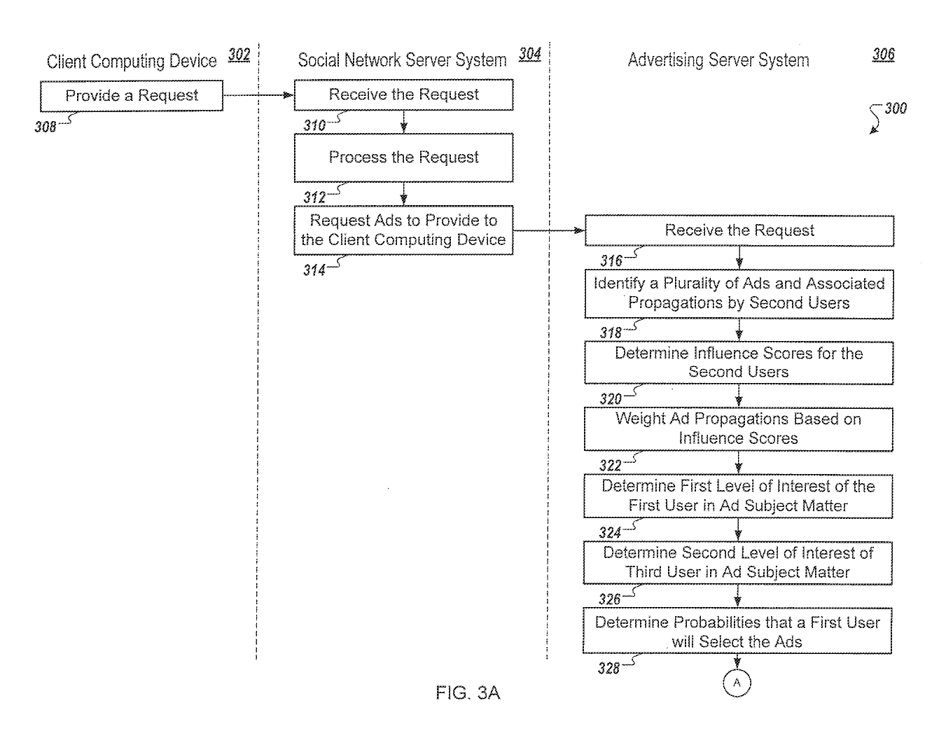

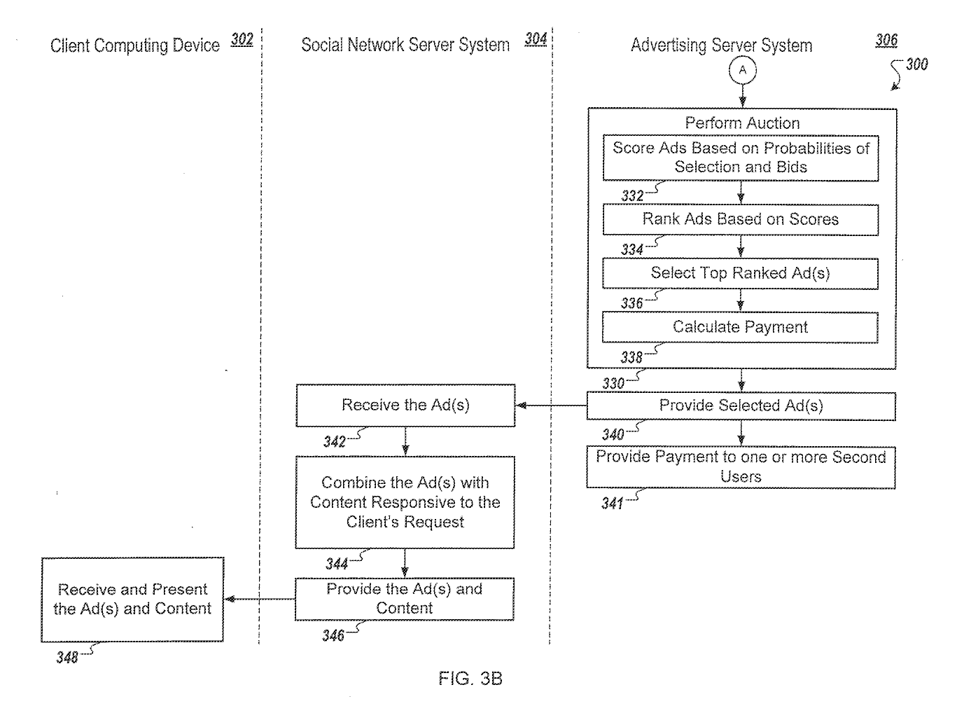

FIGS. 3A-B depict a flowchart showing an example technique 300 for providing advertisements to users of social networks based on probabilities of selection. Portions of the technique 300 are depicted as being performed by a client computing device 302, a social network server system 304, and an advertising server system 306. The client computing device 302 can be any of a variety of computing device, such as the client computing device 104 or 202 described above with regard to FIGS. 1 and 2, respectively. The social network server system 304 can be any of a variety of computer server systems, such as the social network server system 102 or the social network server system 206 described above with regard to FIGS. 1 and 2, respectively. The advertising server system 306 can be any of a variety of server system, such as the advertising server system 100 or 208 described above with regard to FIGS. 1 and 2, respectively.

Referring to FIG. 3A, the technique 300 starts at step 308 by the example client computing device 302 providing a request for content to the example social network server system 304. For example, the client computing device 302 can request a particular user's social network profile page from the social network server system 304. The client computing device 302 can be associated with a first user of a social network, like the user U1 that is associated with the client computing device 104 in FIG. 1.

The social network server system 304 receives the request from the client computing device 302 (step 310) and begins processing the request (step 312). Processing the request can include identifying the content requested by the client computing device 302, such a requested profile page. Processing a request can also include preparing and/or formatting the requested content for transmission to the client computing device 302 so that the content can be properly presented to a user of the client computing device. As part of preparing and/or formatting, one or more electronic documents (e.g., HTML documents, XML documents, etc.) can be generated and/or retrieved by the social network server system 304.

In addition to processing the request at step 312, the social network server system 304 can request advertisements (ads) from the advertising server system 306 (step 314) in response to receiving the request from the client computing device 302.

The advertising server system 306 receives the request for promotional information from the social network server system 304 (step 316), and identifies a plurality of advertisements and associated advertisement propagations by second users (step 318). For example, referring to FIG. 1, the advertising server system 306 can identify the ads A1-A3 described in table 114 and example information depicted in table 116 regarding the associated advertisement propagations by the users U3, U7, and U8 (example second users). The group of second users can be restricted to second users that have at least a threshold acquaintance relationship (e.g., friendship) with the first user on the social network.

The previous propagations by the second users can include explicit and implicit advertisement propagations, such as those described above. The previous advertisement propagations by a second user may have caused an advertisement to be presented to one or more other users of the social network having an acquaintance relationship with the second user. For example, referring to FIG. 1, the previous propagation of the advertisement A1 by the user U3 may have caused the advertisement to have been propagated to other users depicted in the social graph 100, such as the user U2. The propagated advertisement may have been presented to other users with information identifying a second user that propagated the advertisement. Expanding upon the previous example, the advertisement A1 may have been presented to U2 with information (e.g., text located near or on the advertisement) indicating that the advertisement was propagated (e.g., recommended) by user U3.

One or more influence scores for each of the second users can be determined based on the second user's level of influence on the social network (step 320). Influence scores can be determined using a variety of techniques, such as those described above. For example, influence scores for the second users can be determined based on, at least, a level of activity of each of the second users on the social network. Influence scores can include subject matter influence scores that are determined based on a second user's level of influence on the social network with regard to a subject matter of an advertisement. Each of the previous propagations can be weighted based on the determined one or more influence scores for a corresponding second user that performed the previous propagation (step 322). For example, referring to FIG. 1, a previous propagation by a more influential user (e.g., user U3) with a greater influence score can have a greater determined weight than a previous propagation by a less influential user with a lesser influence score (e.g., user U8).

One or more first levels of interest of the first user in subject matter of the plurality of advertisements can be determined by the advertising server system 306 (step 324). For example, referring to step 120 described above with regard to FIG. 1, the advertising server system 100 determines the probability of the user U1 selecting the advertisements A1-A3 based on the determined level of interest of U1 in the subject matter of advertisements A1-A3. The first levels of interest can be determined for the first user based on subject matter that is associated with content generated by the first user and content viewed by the first user on or in association with the social network.

In some implementations, the received request for an advertisement can include information indicating that the advertisement is to be provided to the first user as part of a social network page associated with a third user of the social network. For example, referring the example depicted in FIG. 1, the request 108 from the social network server system 102 for advertisements to present to user U1 indicates that the advertisements are to be presented with a profile page for user U8 (an example third user). One or more second levels of interest for such a third user in subject matter of the plurality of advertisements can be determined (step 326). For example, referring to step 122 depicted in FIG. 1, the probability of selection for user U1 can be determined based on subject matter associated with user U8 and/or his/her profile page. The second levels of interest can be determined for the third user (e.g., user U8) based on, at least, subject matter associated with content contained in the social network page associated with the third user (e.g., user U8's profile page).

Probabilities that the first user will select each of the plurality of advertisements can be determined based on the advertisement propagations (weighted or unweighted), the determined first levels of interest, and/or the determined second levels of interest (step 328). The probabilities of selection can be determined in a variety of ways, such as the multitude of ways described above with regard to FIG. 1. For instance, a first advertisement that was propagated by a greater number of the second users than a second advertisement can increase a first probability that the first user will select the first advertisement by a greater amount than an increase to a second probability that the first user will select the second advertisement.

Referring to FIG. 3B, the advertising server system 306 can perform an auction for an opportunity to present an advertisement to the first user (step 330). For example, referring to step 126 described in FIG. 1, the advertising server system 100 can perform an auction for the opportunity to present an advertisement to user U1 on the profile page of the user U8. The auction can include scoring the plurality of advertisements based upon the determined probabilities of selection by the first user and bids associated with the plurality of advertisements (step 332) and ranking the plurality of advertisements based on the scores (step 334). Example ranked scores for the example advertisements A1-A3 are depicted in the table 134 in FIG. 1. The auction can further include selecting one or more top ranked advertisements (e.g., the first ranked advertisement) of the plurality of advertisements that has a greatest score for presentation to the first user (step 336). Referring to FIG. 1, based on the ranked advertisements A1-A3 depicted in table 134, the advertisement A1 is selected by the server system 100.

The auction can further include calculating a payment for the opportunity to present the one or more top ranked advertisements (e.g., first ranked advertisement) to the first user (step 338). Such a payment can be based on a variety of factors, such as (i) a determined first probability that the first user will select the first ranked advertisement, (ii) a determined second probability that the first user will select a second ranked advertisement of the plurality of advertisements, and (iii) an advertiser's bid associated with the second ranked advertisement. For instance, the calculated payment can be equal to the second probability multiplied by the bid associated with the second ranked advertisement, and then divided by the first probability.

The advertising server system 306 can provide the selected advertisement to the social network server system 304 (step 340). In some implementations, the advertising server system 306 can provide the selected advertisement to the client computing device 302 instead of to the social network server system 304, as described above with regard to FIG. 2.

In some implementations, the advertising server system 306 can provide payment to one or more of the second users for presentation of the one or more selected advertisements to the first user based on propagation of the selected advertisement by the one or more second users (step 341). For example, referring to FIG. 1, the advertising server system 100 can provide remuneration (e.g., money, rewards, discounts, etc.) to the users U3 and/or U8 that propagated the advertisement A1 that is being presented to the user U1.

The social network server system 304 receives the promotional information (step 342) and combines the advertisement with content that is responsive to the request from the client computing device 302 (step 344). For example, code that causes the advertisement to be presented can be added to an electronic document that includes at least a portion of the requested content. The advertisement and the content can be provided by the social network server system 304 to the client computing device 302 (step 346).

The client computing device can receive and present the content and promotional information (step 348). For example, if the client computing device 302 requests web page for a user's profile page from the social network server system 304, the client computing device 302 can receive a web page with the requested directions and one or more advertisements. The client computing device 302 can display the web page and advertisements to a user of the client computing device 302 using a variety of hardware and/or software components, such as a display screen, speakers, a web browser application, and/or scripting applications.

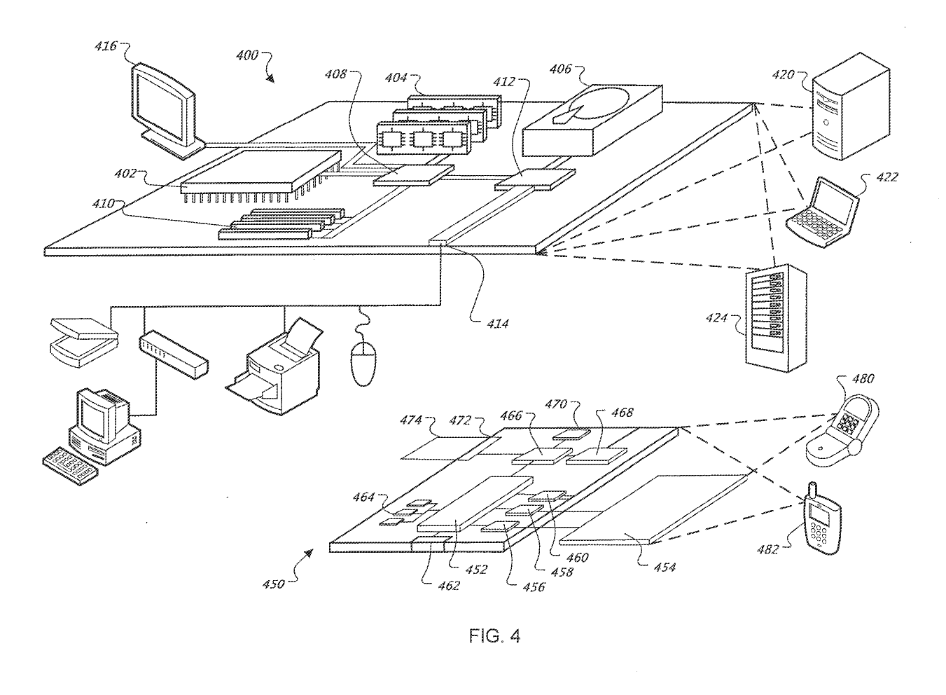

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. Additionally computing device 400 or 450 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452 that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for providing advertisements to users of social networks based on probabilities of selection may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving, at a server system, a request for an advertisement to provide to a first user of a social network;
determining, for each of a plurality of advertisements, a probability that the first user will select the advertisement based, at least in part, on previous propagations of the advertisement by one or more second users of the social network;
scoring, by the server system, the plurality of advertisements based upon the determined probabilities of selection by the first user and bids associated with the plurality of advertisements; and
providing one or more of the plurality of advertisements for presentation to the first user based upon the scoring of the plurality of advertisements.

2. The computer-implemented method of claim 1, wherein the previous propagations by the second users include explicit and implicit advertisement propagations by the second users.

3. The computer-implemented method of claim 1, wherein the previous propagation of the advertisement by the second users caused the advertisement to be presented to one or more other users of the social network having an acquaintance relationship with the second users.

4. The computer-implemented method of claim 3, wherein the propagated advertisement was presented to the other users with information identifying the second users that propagated the advertisement.

5. The computer-implemented method of claim 1, wherein a first advertisement that was propagated by a greater number of the second users than a second advertisement increases a first probability that the first user will select the first advertisement by a greater amount than in increase to a second probability that the first user will select the second advertisement.

6. The computer-implemented method of claim 1, further comprising:
determining one or more influence scores for each of the second users based on the second user's level of influence on the social network; and
weighting each of the previous propagations based on the determined one or more influence scores for a corresponding second user that performed the previous propagation;
wherein the probabilities of selection by the first user are determined based, at least in part, on the weighted previous propagations.

7. The computer-implemented method of claim 6, wherein a previous propagation by a more influential user with a greater influence score has a greater determined weight than a previous propagation by a less influential user with a lesser influence score.

8. The computer-implemented method of claim 6, wherein the influence scores for the second users are determined based on, at least, a level of activity of each of the second users on the social network.

9. The computer-implemented method of claim 6, wherein, for each of the second users, the determined influence scores include subject matter influence scores determined based on the second user's level of influence on the social network with regard to subject matter of the plurality of advertisements.

10. The computer-implemented method of claim 1, wherein each of the second users has at least a threshold acquaintance relationship with the first user on the social network.

11. The computer-implemented method of claim 1, further comprising determining one or more first levels of interest of the first user in subject matter of the plurality of advertisements;
wherein, for each of the plurality of advertisements, the probability that the first user will select the advertisement is further determined based on one or more of the determined first levels of interest for the first user that correspond to subject matter of the advertisement.

12. The computer-implemented method of claim 11, wherein the first levels of interest are determined for the first user based on subject matters associated with content generated by the first user and content viewed by the first user.

13. The computer-implemented method of claim 1, wherein the received request for an advertisement to provide to the first user includes information indicating that the advertisement is to be provided to the first user as part of a social network page associated with a third user of the social network;
the method further comprising determining one or more second levels of interest of the third user in subject matter of the plurality of advertisements;
wherein, for each of the plurality of advertisements, the probability that the first user will select the advertisement is further determined based on one or more of the determined second levels of interest for the third user that correspond to subject matter of the advertisement.

14. The computer-implemented method of claim 13, wherein the second levels of interest are determined for the third user based on, at least, subject matters associated with content contained in the social network page associated with the third user.

15. The computer implemented method of claim 1, further comprising:
performing an auction for an opportunity to present an advertisement to the first user, the auction comprising:
ranking the plurality of advertisements based on the scoring of the plurality of advertisements; and
selecting a first ranked advertisement of the plurality of advertisements that has a greatest score for presentation to the first user, wherein the first ranked advertisement comprises the one or more of the plurality of advertisements provided for presentation to the first user.

16. The computer-implemented method of claim 15, further comprising calculating a payment for the opportunity to present the first ranked advertisement to the first user based on: (i) a determined first probability that the first user will select the first ranked advertisement, (ii) a determined second probability that the first user will select a second ranked advertisement of the plurality of advertisements, and (iii) an advertiser's bid associated with the second ranked advertisement.

17. The computer-implemented method of claim 16, wherein the calculated payment is equal to the second probability multiplied by the bid associated with the second ranked advertisement, divided by the first probability.

18. The computer-implemented method of claim 1, further comprising providing payment to one or more of the second users for presentation of an advertisements to the first user based on propagation of the presented advertisement by the one or more second users.

19. A system for providing advertisements to users of a social network, the system comprising:
one or more computer servers;
an interface to the one or more servers that is configured to receive a request for an advertisement to provide to a first user of a social network;
a selection probability module of the one or more servers that is configured to determine, for each of a plurality of advertisements, a probability that the first user will select the advertisement based upon, at least in part, previous propagations of the advertisement by one or more second users of the social network;
a scoring component of the one or more servers that is configured to score the plurality of advertisements based upon the determined probabilities of selection by the first user and bids associated with the plurality of advertisements; and
an advertisement server module of the one or more servers that is configured to provide one or more of the plurality of advertisements for presentation to the first user based upon the scoring of the plurality of advertisements.

20. A computer program product tangibly embodied in a non-transitory machine-readable storage device, the computer program product including instructions that, when executed, cause operations to be performed, the operations comprising:
receiving a request for an advertisement to provide to a first user of a social network;
determining, for each of a plurality of advertisements, a probability that the first user will select the advertisement based upon, at least in part, previous propagations of the advertisement by one or more second users of the social network;
scoring the plurality of advertisements based upon the determined probabilities of selection by the first user and bids associated with the plurality of advertisements; and
providing one or more of the plurality of advertisements for presentation to the first user based upon the scoring of the plurality of advertisements.
